(19) United States
(12) Patent Application Publication
(10) Pub. No.: US 2008/0108386 A1
(43) Pub. Date: May 8, 2008

(54) MOBILE COMMUNICATION TERMINAL AND METHOD THEREFOR

(76) Inventor: John Hard, Malmo (SE)

Correspondence Address: PERMAN & GREEN, 425 POST ROAD, FAIRFIELD, CT, 06824, US

(21) Appl. No.: 11/556,247

(22) Filed: Nov. 3, 2006

(51) Int. Cl. H04M 1/00

(52) U.S. Cl. 455/557

(57) ABSTRACT

A mobile communications terminal includes an internal memory having a file structure and connection means arranged to upon connection to a docking station enable direct access to the file structure through the docking station. The terminal can include an application and a key associated with the application that activates the application when the key is activated.

### FIELD

The disclosed embodiment generally relates to an arrangement and an apparatus for making a simpler user interface having a minimum of controls and more particularly to an arrangement, an apparatus and a method for updating settings and memory data on a mobile communications terminal.

### BACKGROUND

In modern mobile telephones there are commonly a lot of settings that need to be set and also a lot of applications available. All the applications available and settings can often be construed as difficult to see through, understand and correctly navigate. This has normally been solved by grouping the settings and applications in hierarchical menu systems and implementing clever men navigating programs to enable the user to more easily navigate through the system. This has made the devise quite complicated and difficult to learn and they also require a number of extra keys to be operable.

Furthermore as a mobile phone such as Nokia 3230 is connected to a personal computer specialized programs are often required to make the arrangement function properly again requiring installation and training.

Another drawback of the contemporary mobile phones is that it is difficult to control its usage both for parents wanting to control their children's phone usage and for employees controlling their employer's phone usage. This difficulty lies in the complex navigating systems being so complex that they are easily manipulated as they offer many possibilities.

Consequently, there is a need to provide a convenient and efficient way for a user to handle settings in an easy way that could also be difficult to manipulate against the user's will.

### SUMMARY OF THE INVENTION

In view of the above, it would be advantageous to solve or at least reduce the problems discussed above.

Generally, the above objectives are achieved by the attached independent patent claims.

According to a first aspect of the invention there has been provided a mobile communications terminal comprising an internal memory having a file structure and connection means arranged to upon connection to a docking station enable direct access to said file structure through the docking station.

In a further embodiment the file structure comprises files associated with at least one application in said mobile phone.

In a further embodiment the at least one application being at least one from the set of phonebook, music player and settings.

In a further embodiment the file contains data for said associated at east one application, wherein said data is possibly in text format.

A second aspect of the invention is an arrangement for updating settings on a mobile communication terminal according to claim 1 comprising said mobile communications terminal and a docking station.

A third aspect of the disclosed embodiments is a mobile communication terminal comprising at least one application and a keypad having at least on key, wherein said at least one key is associated with said at least one application and said mobile communication terminal being arranged to activate one of said at least one application upon user activation of said corresponding key.

In a further embodiment the application has at least one content item which is scrollable for selection by further activation of said corresponding key, each depressing resulting in selecting the next content item.

In a further embodiment the selected content item is activated automatically.

In a further embodiment the mobile communication terminal also comprises an activation key wherein the selected content item is activated upon depression of said activation key.

A fourth aspect of the invention is a method comprising:
a) receiving depression input of a key associated with an application;
b) launching said application;
c) presenting a content item associated with said application;
d) activating said content item.

In a further embodiment the activation is done upon receiving depression input of an activation key.

In an alternative embodiment the activation is automatic.

In a further embodiment the method further comprises receiving further depression input of said key associated with said application and presenting another content item.

Other features and advantages of the disclosed embodiments will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device; component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

Embodiments will now be described in more detail, reference being made to the enclosed drawings, in which:

FIG. 1 is a schematic illustration of a cellular telecommunication system, as an example of an environment in which the disclosed embodiments may be applied.

FIG. 2 is a schematic front view illustrating a mobile terminal according to an embodiment.

FIG. 3 is a schematic block diagram representing an internal component, software and protocol structure of the mobile terminal shown in FIG. 2.

FIG. 4 is a schematic view of an arrangement according to one embodiment with a mobile communication terminal connected to a docking station.

FIG. 5 is a block view of a file system according to the invention.

FIG. 6 is another block view of a file system according to the one embodiment

FIG. 7 is three schematic views of three exemplary embodiments a, b and c.

FIG. 8 is a flow chart of a method according to the disclosed embodiments.

### DETAILED DESCRIPTION OF THE INVENTION

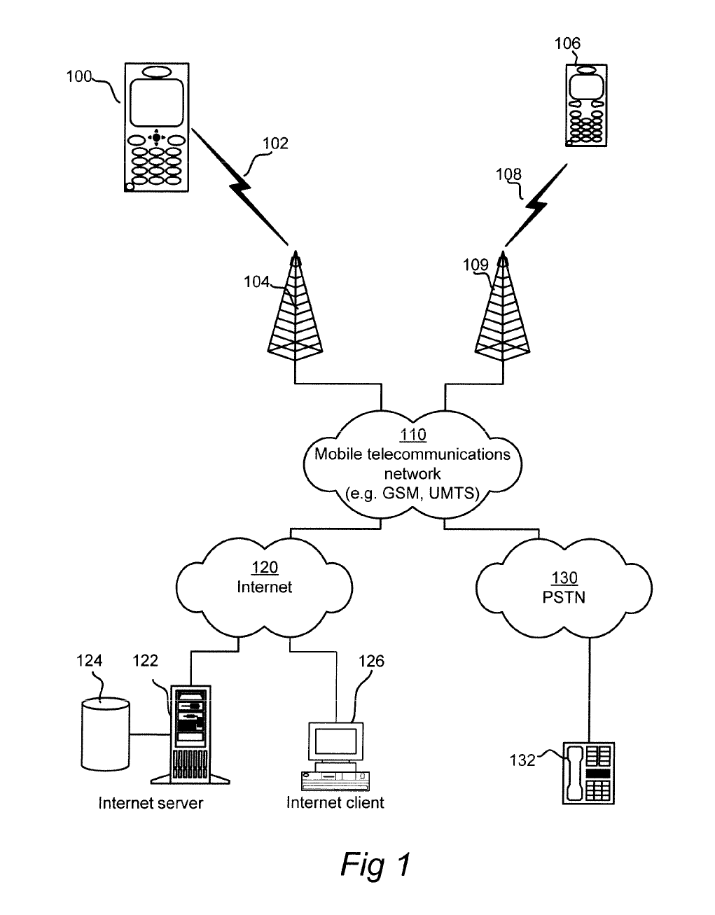

FIG. 1 illustrates an example of a cellular telecommunications system in which aspects of the invention may be applied. In the telecommunication system of FIG. 1, various telecommunications services such as cellular voice calls, www/wap browsing, cellular video calls, data calls, facsimile transmissions, music transmissions, still image transmissions, video transmissions, electronic message transmissions and electronic commerce may be performed between a mobile terminal 100 according to the disclosed embodiments and other devices, such as another mobile terminal 106 or a stationary telephone 132. It is to be noted that for different embodiments of the mobile terminal 100 and in different situations, different ones of the telecommunications services referred to above may or may not be available; the invention is not limited to any particular set of services in this respect.

The mobile terminals 100, 106 are connected to a mobile telecommunications network 110 through RF links 102, 108 via base stations 104, 109. The mobile telecommunications network 110 may be in compliance with any commercially available mobile telecommunications standard, such as GSM, UMTS, D-AMPS, CDMA2000, FOMA and TD-SCDMA.

The mobile telecommunications network 110 is operatively connected to a wide area network 120, which may be Internet or a part thereof. An Internet server 122 has a data storage 124 and is connected to the wide area network 120, as is an Internet client computer 126. The server 122 may host a www/wap server capable of serving www/wap content to the mobile terminal 100.

A public switched telephone network (PSTN) 130 is connected to the mobile telecommunications network 110 in a familiar manner. Various telephone terminals, including the stationary telephone 132, are connected to the PSTN 130.

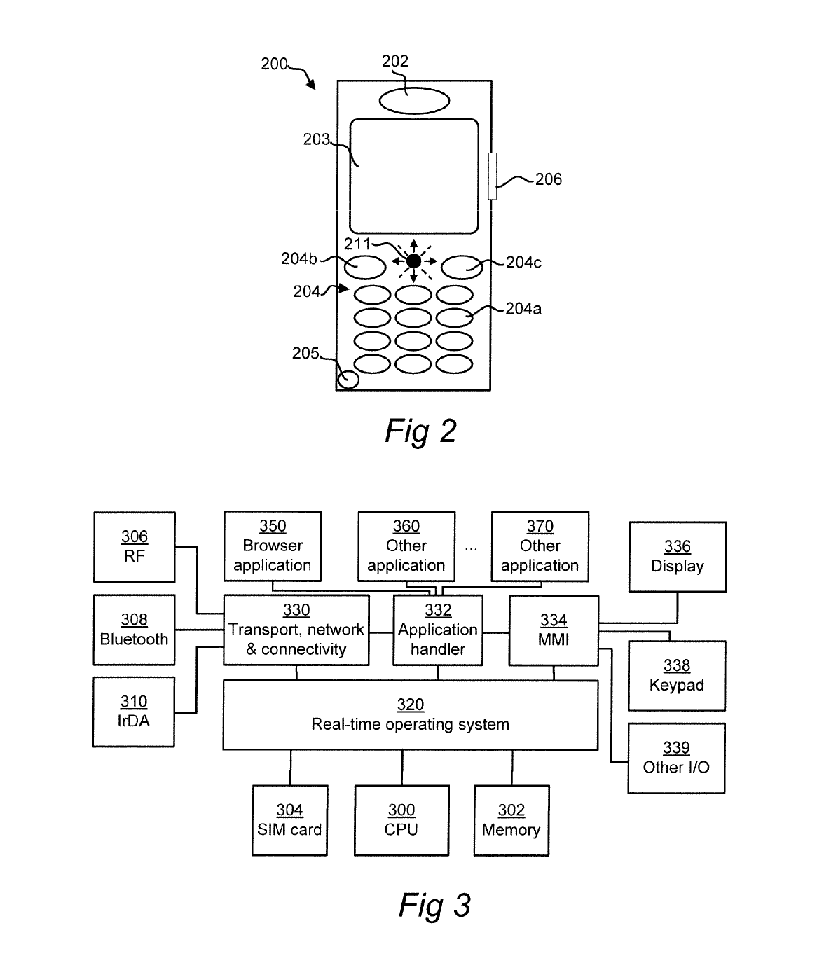

An embodiment 200 of the mobile terminal 100 is illustrated in more detail in FIG. 2. The mobile terminal 200 comprises a speaker or earphone 202, a microphone 205, a display 203 and a set of keys 204 which may include a keypad 204a of common ITU-T type (alpha-numerical keypad representing characters “0”-“9”, “*” and “#”) and certain other keys such as soft keys 204b, 204c and a joystick 211 or other type of navigational input device. As we will see later many of these keys could be made redundant according to the embodiments. The mobile terminal also comprises connection means 206 for connecting to a docking station such as a personal computer, a personal digital assistant or a specialized docking station. The connecting means could be either one of a serial connection such as a Universal Serial Bus (USB) connection, a wireless connection, such as a Bluetooth™ connection or an IrDA connection or a specialized connection.

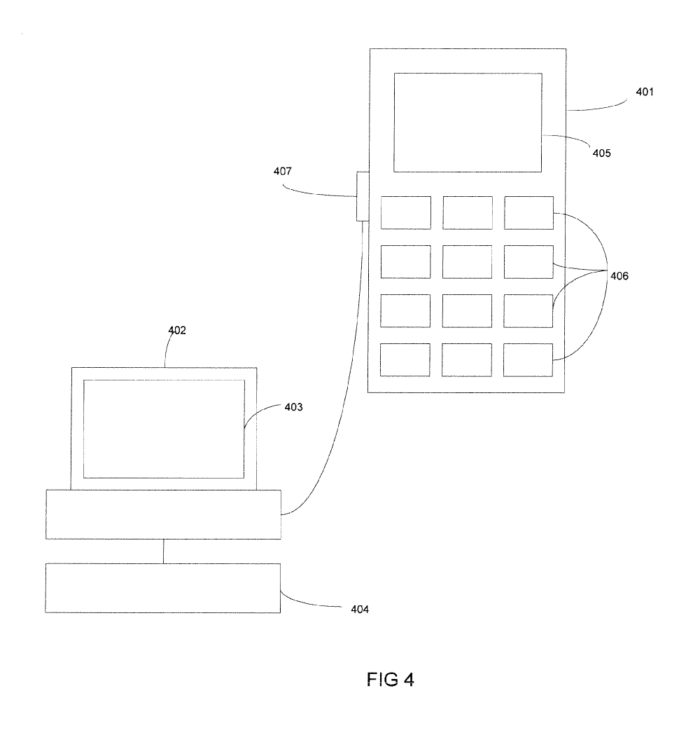

The internal component, software and protocol structure of the mobile terminal 200 will now be described with reference to FIG. 3. The mobile terminal has a controller 300 which is responsible for the overall operation of the mobile terminal and is preferably implemented by any commercially available CPU (“Central Processing Unit”), DSP (“Digital Signal Processor”) or any other electronic programmable logic device. The controller 300 has associated electronic memory 302 such as RAM memory, ROM memory, EEPROM memory, flash memory, or any combination thereof. The memory 302 is used for various purposes by the controller 300, one of them being for storing data and program instructions for various software in the mobile terminal. The software includes a real-time operating system 320, drivers for a man-machine interface (MMI) 334, an application handler 332 as well as various applications. The applications include a browser application 350, as well as various other applications 360 and 370, such as applications for voice calling, video calling, sending and receiving SMS, MMS or email, an instant messaging application, a phone book application, a calendar application, a control panel application, a camera application, a media player, one or more video games, a notepad application, etc.

The MMI 334 also includes one or more hardware controllers, which together with the MMI drivers cooperate with the display 336/203, keypad 338/204 as well as various other I/O devices such as microphone, speaker, vibrator, ringtone generator, LED indicator, etc. As is commonly known, the user may operate the mobile terminal through the man-machine interface thus formed.

The software also includes various modules, protocol stacks, drivers, etc., which are commonly designated as 330 and which provide communication services (such as transport, network and connectivity) for an RF interface 306, and optionally a Bluetooth interface 308 and/or an IrDA interface 310. The RF interface 306 comprises an internal or external antenna as well as appropriate radio circuitry for establishing and maintaining a wireless link to a base station (e.g. the link 102 and base station 104 in FIG. 1). As is well known to a man skilled in the art, the radio circuitry comprises a series of analogue and digital electronic components, together forming a radio receiver and transmitter. These components include, i.a., band pass filters, amplifiers, mixers, local oscillators, low pass filters, AD/DA converters, etc.

The mobile terminal also has a SIM card 304 and an associated reader. As is commonly known, the SIM card 304 comprises a processor as well as local work and data memory.

In one embodiment, see FIG. 4, a mobile phone 401 has a USB connection 407 (206 in FIG. 2) for connecting to a docking station in this case to a personal computer, PC 402. The PC personal computer has a user interface consisting of a screen 403 which is significantly larger (not visible in figure) than the mobile phones screen 405, a keyboard 404 of a QWERTY type having significantly more keys than the mobile phone's keypad 406 and possible also some pointing device such as a mouse, making the personal computer 402 more adaptable and flexible to use. As a connection is made between the mobile phone 401 and the personal computer 402 through the USB cable 407 certain data is exchanged between the two devices making the mobile phone's 401 internal memory 302 available directly through the personal computer 402. The mobile phone's 401 memory 302 could appear like a USB connected external storage device on the personal computer 402.

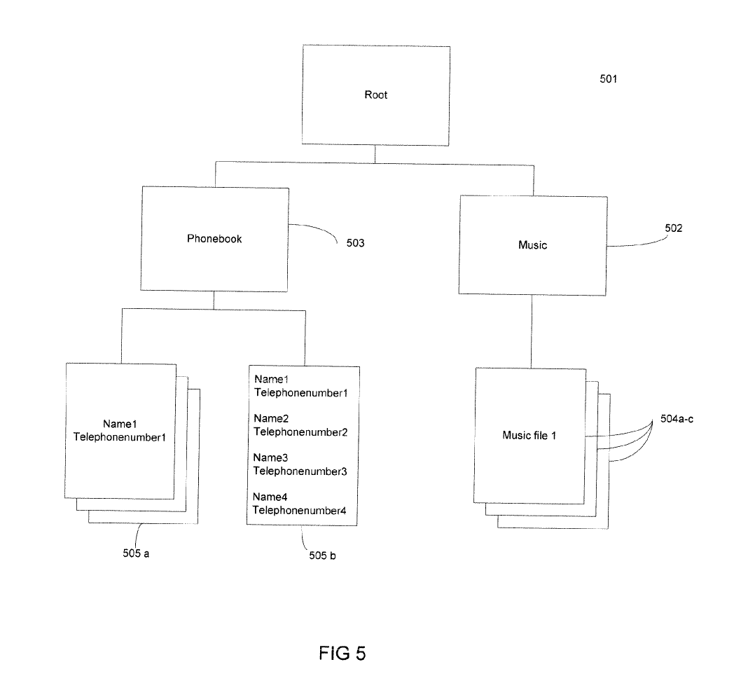

Also with reference to FIG. 5 the mobile phone's 401 memory 302 is presented in a hierarchical file structure 501, one main folder for each application or data area such as phonebook 503, settings (not shown), music player 502 and other applications (not shown).

Here we will focus on the phonebook 503 but it should be understood that the same embodiment also applies to other settings.

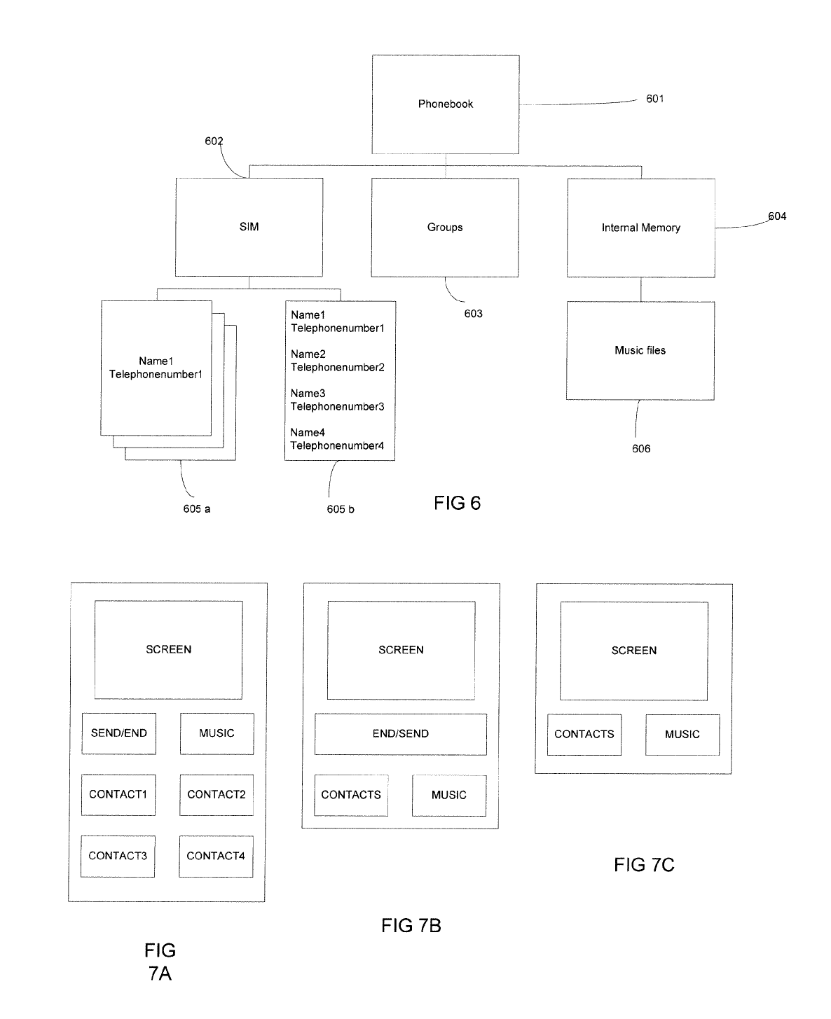

The following will be made with reference to FIG. 6. As a user accesses the memory 302 he will view the current memory structure 501 and browse through it like normal files. Any arrangement of folders and files are possible. Here are a few examples:

The phonebook is the main folder 601.

The subfolders are groups 603 and/or different memories, like SIM (Subscriber Identification Module) card 602 and external memory 604, ie one sub folder for each sub category.

In each subfolder there is a file 605 b holding all the details of the different contacts belonging to that sub category. In one embodiment a special file holds all the contacts and their details 605 b. Using this scheme a contact is added by typing in the name and the number with one kind of separator in between and another kind of separator for each contact. The order of the details could be made irrelevant and a parser could parse the information as it is generally easy to differentiate between a phone number and a name. using a linefeed as a separator for details and a new line for contacts makes the contact list very intuitive to read, create and edit.

Another alternative having almost the same structure is where each contact has it's own file 605 a. This makes it easier to link a contact between different groups 603 as a copy action would otherwise be necessary, possibly automatically by the mobile phone's CPU. It could also be possible to rearrange the file structure internally so that unnecessary copies would be deleted.

By storing all the data in the files in text format, preferably without any formatting, provides for easy handling, smaller memory requirements and larger compatibility of docking stations and mobile terminals.

Naturally it should be understood that a file system only having the main folder and the contact files or just one file having all the contacts is also possible and included in the scope of the invention. Actually it is the preferred embodiment for a mobile communications terminal having a minimum of applications.

As an alternative there could be a software program or other application in the docking station that accesses the file structure in the mobile phone for making the access more easy.

Securing the access of the mobile computer is very easy according to the invention as one only needs to either pair a mobile communications terminal with a docking station through a certificate scheme or by assigning a password to the memory access.

There could also be a settings folder having the different settings available. One possible file structure could be having one file for each setting or a common file for all settings. The settings could be prewritten in the file possibly with examples or listings of values possible in the file and all the user would have to do is to add the current setting. One example could look like (using a common file):

| Settings | Changed settings |
|---|---|
| SMS server: | SMS server: +4533292929 |
| Sound(silent/low/loud): | Sound(silent/low/loud): low |
| Call guarding(on/off): | Call guarding(on/off): on |

The feature Call guarding is basically a program that checks the identities of all incoming calls and compares them to a list of accepted or approved contacts before switching the call to the user. If the incoming caller is not on the list no notification is given and the call is automatically rejected. By using this parents can safe guard their children from being called by child molesters or such. The Call guard list would also be available as either a common file or a group of files, one of each approved contact. These files could be linked copies of the original contacts. Or the Call guard list could just be the contact list.

A mobile communications terminal having the settings accessible in this way only needs a minimum of buttons as no complicated menu navigating system is necessary to change settings or add and/or edit contacts, see FIG. 7.

In one embodiment the phone only has the ten number keys and one speed dial assigned to each dial. Longpressing a single key would then call the speed dial assigned to it and typing in a number would cause the mobile communications terminal to call that number, much like a wireless telephone.

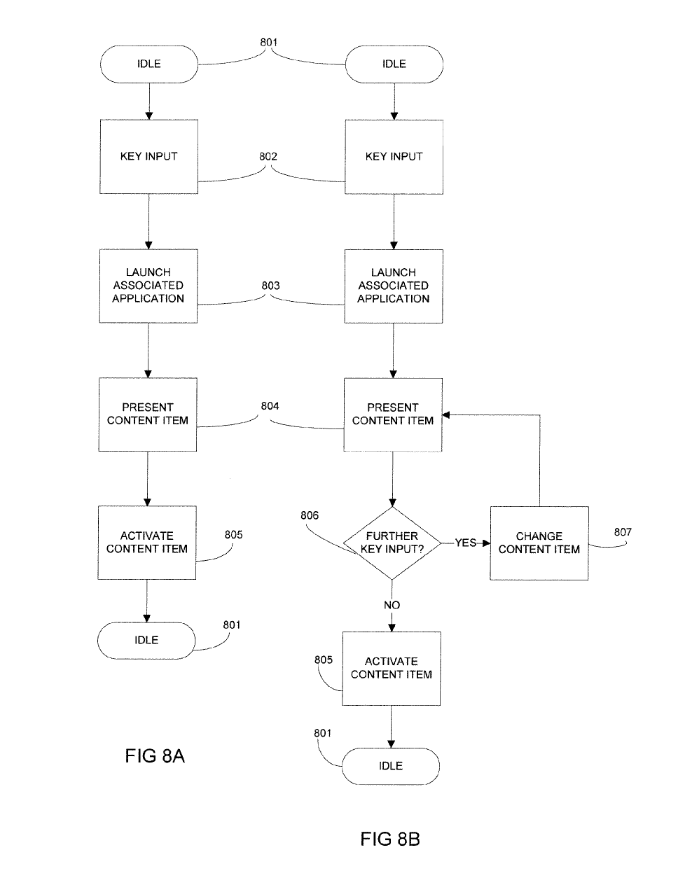

In a further embodiment the phone has even fewer keys arranged such as one key for each contact and/or one key for each application. One example could be a phone with six keys, see FIG. 7A. Four keys for four different contacts CONTACT1, CONTACT2, CONTACT3 and CONTACT4, one key for ending or accepting ie a SEND/END key (if something is active it is ended, if it is inactive it is accepted ie executed), and one button MUSIC for a music application. With reference to FIG. 8, playing music could be done by pressing the music button MUSIC step 802 which would launch the music application step 803 (or any other application) and show the first content item, ie song in the list available step 804. Starting the playback could be done either automatically or alternatively by accepting, ie activating it by pressing the SEND/END key step 805. The music list could be scrolled by repeatedly pressing the music button MUSIC step 806 until the favourite song is found 807 and presented to the user step 804.

Adding a music file is also quite easy as it can simply be dragged and dropped to the folder 606 containing music files. A sub folder could be a playlist containing links to the music files.

The arrangement above for the music key could also be used for the contact book. With reference to FIG. 8 a user presses the contact key CONTACT, step 802, thereby launching the phonebook application step 803 and showing or presenting the first contact step 804. If the user wants to call this contact the contact is activated step 805 otherwise the user presses the contact key CONTACT again, step 806 and the next contact is displayed steps 807 and 804, until the user finds the contact he wishes to communicate with step 805. The phone could have one button CONTACTS, MUSIC for each category (phonebook, music player etc), see FIG. 7B and also FIG. 8, that launches the corresponding application step 802. Further pressings of that button CONTACTS, MUSIC step 806 scrolls to the desired element or content item step 807, ie contact or music file (song) which is then activated step 805 either automatically (possibly after a timeout) or by pressing an activation key SEND/END. Using the time out activation or automatic activation makes the SEND/END key redundant, see FIG. 7C. Accepting an incoming call could be done by either using “any key answer”, that is the call is accepted upon depression of any key CONTACTS, MUSIC, or by pressing one pre-specified button, in this example the contact button CONTACT would be most intuitive, and to reject a call, the other button MUSIC could be pressed. The two buttons' accepting and rejection functions could be further indicated by having the keys in different colors for example the contact button CONTACT in green and the music button MUSIC in red. Any use fo different icons indicating the key's or button's functionality could also be used. Thereby a mobile communications terminal allowing for easy scrolling through a (limited) phonebook, making a call, accepting and rejecting a call and also having an easy to use music player, or other application, is realised using only two buttons while still allowing an easy way of changing the settings using a docking station and also protecting the settings.

By having a speech program in the mobile phone the names of the scrolled data, also called content items, could be read out such as the contact names, song titles etc. The content could thereby both be presented on a screen and/or by speech output. This way the screen could also be made redundant further lowering the price of the mobile phone. It would also help illiterate people. Thereby the content could both be presented on a screen and/or by speech output.

Generally arranging data in folders with specific files (ie one file for each item) is easier to handle for copying, linking and grouping, but sometimes more difficult to create, such as when creating a contact list where one has to create on file for each contact instead of simply typing in the details for each contact in one file.

Using the direct access file system according to the disclosed embodiments as described above, allows a user to access the settings in a simple way while still having a very easy to use and not confusing user interface of the mobile communication terminal, said mobile communication terminal also being easy to control, without requiring any special soft ware such as the Nokia™ PC suite to be installed and adapted to the current mobile communication model. An installation that can be perceived to be difficult by some users not accustomed to modern technology. A further advantage of the disclosed embodiment's file system with its direct access is that it is easy for a person to get help with settings in any store. As long as the store has a personal computer och other docking station a user only has to go into the store and connect the mobile communication terminal and the store personnel can help with the settings, editing and creating contacts and so on for all models using the disclosed embodiment's file system.

What is claimed is:

1. A mobile communications terminal comprising an internal memory having a file structure and connection means arranged to upon connection to a docking station enable direct access to said file structure through the docking station.

2. A mobile communications terminal according to claim 1 wherein said file structure comprises files associated with at least one application in said mobile phone.

3. A mobile communications terminal according to claim 2 wherein said at least one application being at least one from the set of phonebook, music player and settings.

4. A mobile communications terminal according to claim 2 wherein said file contains data for said associated at east one application.

5. A mobile communication terminal according to claim 4, wherein said data is in text format.

6. An arrangement for updating settings on a mobile communication terminal according to claim 1 comprising said mobile communication terminal and a docking station.

7. A mobile communication terminal comprising at least one application and a keypad having at least on key, wherein said at least one key is associated with said at least one application and said mobile communication terminal being arranged to activate one of said at least one application upon user activation of said corresponding key.

8. A mobile communication terminal according to claim 7 wherein said application has at least one content item which is scrollable for selection by further activation of said corresponding key, each depressing resulting in selecting the next content item.

9. A mobile communication terminal according to claim 8 wherein the selected content item is activated automatically.

10. A mobile communication terminal according to claim 8 comprising an activation key wherein the selected content item is activated upon depression of said activation key.

11. A method comprising:
a. receiving depression input of a key associated with an application;
b. launching said application;
c. presenting a content item associated with said application;
d. activating said content item.

12. A method according to claim 11, wherein said activation is done upon receiving depression input of an activation key.

13. A method according to claim 11, wherein said activation is automatic.

14. A method according to claim 11, further comprising receiving further depression input of said key associated with said application and presenting another content item.
